(19) United States
(12) Patent Application Publication
(10) Pub. No.: US 2025/0378707 A1
(43) Pub. Date: Dec. 11, 2025

(54) Form Processing Using Image Matching

(71) Applicant: OPTUM, INC., Minnetonka, MN (US)

(72) Inventor: Arunbh Yashaswi, Noida (IN)

(21) Appl. No.: 18/736,892

(22) Filed: Jun. 7, 2024

(51) Int. Cl. G06V 30/412; G06F 40/174; G06F 40/186; G06T 5/50; G06T 5/77; G06V 10/75; G06V 30/19; G06V 30/418

(52) U.S. Cl. CPC G06V 30/412; G06F 40/174; G06F 40/186; G06T 5/50; G06T 5/77; G06V 10/757; G06V 30/1908; G06V 30/19093; G06V 30/418; G06T 2207/20081; G06T 2207/20084; G06T 2207/30176

(57) ABSTRACT

The disclosure is directed to extracting data from a page of an input document (e.g., a filled-out form) by identifying a matching reference document page. A system and a computer-implemented method include computing a set of keypoints within a document page and a plurality of filtered sets of matching keypoints for a plurality of reference document pages. A homographic transformation to match an input page with candidate reference pages based on keypoints forms and evaluating the respective registration forms the basis for identifying a matching reference document page. Based on the identified matching reference document page, a template may be created to extract data from the input document page.

### FIELD

Generally, the present disclosure relates to algorithms for extracting data from digital images of documents that include forms and information within fields of the forms. More specifically, the techniques of this disclosure use keypoint identification and homography to identify a matching reference document to aid in extracting form data.

### BACKGROUND

Historically, structured documents such as forms have served as vehicles for collecting a wide variety of information including, for example, patient information for medical data repositories. Even with the advent of digital data collection techniques, a large volume of information is still aggregated via printed forms that are filled out by hand. Extracting structured and partially structured data from these “analog” forms can be a laborious data entry process. Automated techniques for extracting data from forms have been under development. In particular, optical character recognition (OCR) techniques can be used to recognize handwritten text. Such techniques are particularly useful when a high-quality digital image of a structured form with a known template is available. Work processes to scan and digitally process forms as they are completed can help automatically populate databases with extracted data. Often, however, such work processes are impractical at the points where forms are collected. In many cases, for example, it is more convenient to quickly take a picture of a form with a portable device. Such pictures may suffer from perspective distortions, and even lighting, and degradation of the documents before a picture can be taken. Furthermore, at the time of processing, a template corresponding to the structured document image may not be available. That is, a form can be one of a plurality of forms that either collect different data, or are different versions of a form that collects the same data. Consequently, accurately identifying an appropriate template or a blank reference document for an incoming document to be processed is a challenge that still requires an effective solution. Besides having good accuracy, the effective solution should be computationally efficient and not rely on prohibitive training requirements such as those associated with certain deep learning (DL) systems.

### SUMMARY

In some aspects, a computer-implemented method includes computing, by one or more processors, a set of keypoints within a document page, and identifying, by the one or more processors, a plurality of filtered sets of matching keypoints for a plurality of reference document pages. Identifying the plurality of filtered sets of matching keypoints includes, for each reference document page of the plurality of reference document pages, identifying a filtered set of matching keypoints between (i) the set of keypoints within the document page and (ii) a set of keypoints within the reference document page. The computer-implemented method further includes computing, by the one or more processors, a plurality of metrics for the plurality of reference document pages. Computing the plurality of metrics includes, for each reference document page of the plurality of reference document pages, computing a homographic transformation between the document page and the reference document page based at least in part on the filtered set of matching keypoints identified for the reference document page. Computing the plurality of metrics further includes, for each reference document page of the plurality of reference document pages, computing a respective metric, of the plurality of metrics, that indicates a quality of match between the document page and the reference document page based at least in part on the computed homographic transformation. The computer-implemented method further includes selecting, by the one or more processors, a matching reference document page based at least in part on the plurality of metrics, and storing, by the one or more processors, a data object indicative of the matching reference document page.

In some aspects, a system includes memory and one or more processors communicatively coupled to the memory. The one or more processors are configured to compute a set of keypoints within a document page and identify a plurality of filtered sets of matching keypoints for a plurality of reference document pages. Identifying the plurality of filtered sets of matching keypoints includes, for each reference document page of the plurality of reference document pages, identifying a filtered set of matching keypoints between (i) the set of keypoints within the document page and (ii) a set of keypoints within the reference document page. The one or more processors are further configured to compute a plurality of metrics for the plurality of reference document pages. Computing the plurality of metrics includes, for each reference document page of the plurality of reference document pages, computing a homographic transformation between the document page and the reference document page based at least in part on the filtered set of matching keypoints identified for the reference document page. Computing the plurality of metrics further includes, for each reference document page of the plurality of reference document pages, computing a respective metric, of the plurality of metrics, that indicates a quality of match between the document page and the reference document page based at least in part on the computed homographic transformation. The one or more processors are further configured to select a matching reference document page based at least in part on the plurality of metrics, and to store a data object indicative of the matching reference document page.

In some aspects, one or more non-transitory computer-readable storage media include instructions that, when executed by one or more processors, cause the one or more processors to compute a set of keypoints within a document page and identify a plurality of filtered sets of matching keypoints for a plurality of reference document pages. Identifying the plurality of filtered sets of matching keypoints includes, for each reference document page of the plurality of reference document pages, identifying a filtered set of matching keypoints between (i) the set of keypoints within the document page and (ii) a set of keypoints within the reference document page. The instructions, when executed, further cause the one or more processors to compute a plurality of metrics for the plurality of reference document pages. Computing the plurality of metrics includes, for each reference document page of the plurality of reference document pages, computing a homographic transformation between the document page and the reference document page based at least in part on the filtered set of matching keypoints identified for the reference document page. Computing the plurality of metrics further includes, for each reference document page of the plurality of reference document pages, computing a respective metric, of the plurality of metrics, that indicates a quality of match between the document page and the reference document page based at least in part on the computed homographic transformation. The instructions, when executed, further cause the one or more processors to select a matching reference document page based at least in part on the plurality of metrics, and to store a data object indicative of the matching reference document page.

### BRIEF DESCRIPTION OF THE DRAWINGS

The Figures described below depict preferred embodiments for purposes of illustration only. One skilled in the art will readily recognize from the following discussion that alternative embodiments of the systems and methods illustrated herein may be employed without departing from the principles of the disclosure described herein.

FIG. 1 depicts an example computing environment in which various embodiments of the present disclosure may be implemented.

FIG. 2 depicts an example sequence for extracting data from a structured document, in accordance with various embodiments described herein.

FIG. 3 depicts an example sequence for selecting a matching reference document, in accordance with various embodiments described herein.

FIG. 4 depicts example operations performed on a document page, in accordance with various embodiments described herein.

FIGS. 5A and 5B depict a flow diagram representing an example computer-implemented method, in accordance with various embodiments described herein.

### DETAILED DESCRIPTION

Broadly speaking, the techniques of the present disclosure relate to algorithms for extracting data from digital images of documents that include forms and information within fields of the forms. The algorithms of the present disclosure make use of reference documents (e.g., blank forms). Specifically, the algorithms of this disclosure select a matching reference document or document page based on a received document or document page that includes data (e.g., a filled-out form). Furthermore, in some embodiments, the algorithms of this disclosure use the selected matching reference document or document page to isolate a portion of the received document or document page that contains data to be extracted. The algorithms may include optical character recognition (OCR) or another suitable technique to then extract the data from the isolated portion of the received document. In some embodiments, the extracted data is then be stored in a suitable database.

For the discussion within the present disclosure, it may be assumed that received documents are processed page by page. That is, example computer-based systems and methods of this disclosure are configured to select a matching page of a reference document based on the received page of the document containing data to be extracted. Broadly speaking, a page may be any suitably delineated portion of a document or the entirety of the document. To select the matching reference document page based on the received document page, the algorithms of this disclosure compute a keypoint comparison between keypoints within the received document page and respective keypoints in reference documents. The keypoint comparison identifies potential matching keypoints between the received and the reference document pages and filters the potential matching keypoints according to suitable criteria to generate a filtered set of matching keypoints. Pairs of matching keypoints from the filtered set of matching keypoints may be referred to as “good matches.” The example systems implementing the algorithms are configured to register the received document page with candidate reference document pages using homographic transformations based on the respective matching keypoints (from the filtered set of matching keypoints). The systems are further configured to compute, for each homographic transformation of the received document page onto one of the candidate reference document pages, a metric indicating a quality of match between the received document page and a respective reference document page. To that end, in some embodiments, an example system computes a feature vector based on one or more homographic transformations and use the feature vector as an input into a machine learning (ML) model. For example, a decision-tree-based ML model, such as a random forest model, a convolutional neural network (CNN), a support vector machine (SVM), or any other suitable ML model may take as an input the feature vector and output a quality metric. In some embodiments, multiple intermediate quality metrics (e.g., from multiple ML models or other computations) are combined to compute a total quality metric. Example systems use the quality metric to identify the matching reference document. For example, the system may select the reference document having the highest quality metric with respect to the homographic transformation of the received document page. In some embodiments, the quality metric is indicative of a probability that the received document page (e.g., a filled-out form) corresponds to a respective reference document page (e.g., a blank form).

Once a matching reference document page is identified, a system may “subtract” the matched reference document page from the received document page to isolate, within the received document page, regions of interest (ROI) that include data to be extracted. Subtraction, as used in the present disclosure, broadly means removing parts of the received document page that correspond to the reference page. For example, if a blank form is filled out by hand, an example system may remove the blank form from the received page, substantially leaving only the handwritten portion. The handwritten portion may subsequently be digitized using OCR or other suitable techniques.

The techniques of the present disclosure have technical advantages over conventional techniques. For example, the use of keypoint matching and homographic transformations carries comparatively small computational cost with respect to conventional techniques, and/or identifies matching documents more precisely than conventional techniques.

Some conventional techniques rely on OCR to identify matching documents by identifying matching text within received and reference document pages. Applying OCR to identify documents can be computationally intensive and time consuming. Furthermore, reference documents may have substantial text similarity. For example, two reference documents may be versions of the same form, thereby sharing much of the text. Small changes to the form, however, may significantly complicate extraction of data from the form fields. The techniques of the present disclosure, in contrast, use image-based algorithms to match received and reference document pages using image processing techniques. These techniques can be faster than OCR conversions, particularly with forms that contain a lot of text. Furthermore, the image-based techniques of the present disclosure are more suitable for accurately differentiating reference documents based on occasional changes in font and text position on page, which are easily missed by text-based techniques. More generally, the OCR techniques can fail when handling similar forms due to relative infrequency of unique words.

Conventional image-based techniques that rely on CNNs or other deep learning (DL) models carry a higher computational load than the techniques of the present disclosure. Furthermore, CNNs or other DL models configured to identify the received documents require large sets of labeled training data that can be challenging to obtain. Such techniques generally also require retraining of the models when a new reference document is added. The DL techniques are prone to overfitting, have high complexity and low interpretability, and give rise to hosting challenges for the model and feedback systems for the model. Additionally, such techniques still require image registration between the received and the identified reference document. In the techniques of the present disclosure, the registration is computed using homography in the identification stage, obviating the need for repeating the transformation.

Other conventional techniques are based on comparing statistical measures of images, such as images of documents. For example, histogram-based similarity measures rely on measuring similarity from color distributions. Such techniques disregard the interdependence of pixels essential for understanding context and structure of an image. These conventional techniques, in contrast to the techniques of this disclosure, are insensitive to local variations within images. Furthermore, in contrast to the histogram-based similarity measures, the techniques of this disclosure do not rely on hard coding of the value for similarity which varies for different images. Thus, the techniques of this disclosure can more accurately discriminate among statistically similar-looking documents, considerably improving performance. Furthermore, the techniques of this disclosure allow for variation of light conditions under which images of documents are obtained, thereby relaxing the requirements on imaging equipment. The advantages described above also apply to the comparison of the techniques of this disclosure with other structural and spatial similarity measures. For example, mean structural similarity (MSSIM) compares the structural information and luminance between images to measure their perceptual similarity. Unlike the techniques of the present disclosure, however, MSSIM has difficulty handling deformations and distortions (especially nonlinear deformation and distortion), is sensitive to transformations, and vulnerable to noise. The techniques of this disclosure can incorporate certain structural information comparisons in a selection stage of a matching reference document. The techniques of this disclosure, however, provide considerably more accurate results than using statistical structural techniques alone. Once again, the techniques of this disclosure enable computationally efficient matching of an incoming document to a reference document even when the incoming document is imaged in a distorted manner and with poor or variable illumination.

Of course, it should be appreciated that the advantages and technical improvements described above and elsewhere herein are not the only advantages and/or technical improvements that may be realized using the techniques described herein. Other advantages and/or technical improvements to the functioning of a computer itself or other technologies or technical fields may be apparent to one of ordinary skill in the art. Moreover, while described herein primarily in the health care claims context, the techniques described herein may be readily applied in any suitable field for any suitable purpose.

### Example Computing Environment Including a Computing System

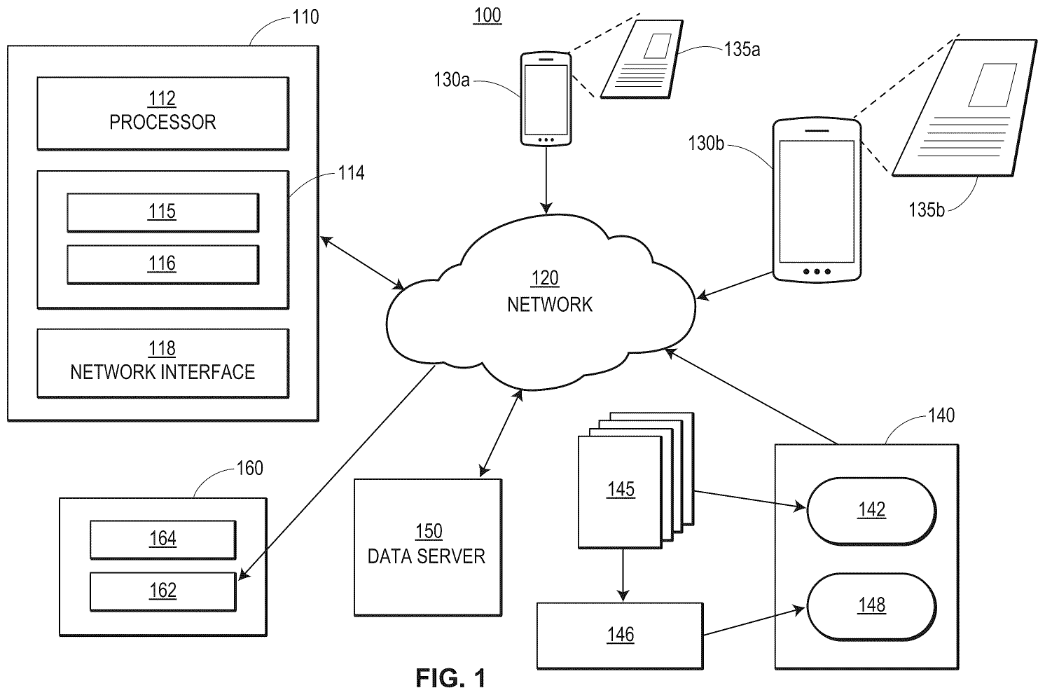

FIG. 1 depicts an example computing environment 100 in which various techniques of the present disclosure may be implemented. The computing environment 100 includes a computing system 110, which may perform at least some of the techniques of this disclosure. The computing system 110 includes a processor 112 communicatively coupled to memory 114, which may store algorithms 115 and 116, and communicatively coupled to a network interface 118. The computing system 110 is coupled, by way of the network interface 118, to a network 120.

The computing environment 100 additionally includes example devices 130a, b communicatively coupled to the network 120. The example devices 130a, b are configured to digitize example documents 135a, b for processing by the computing system 110. To that end, the devices 130a, b are communicatively connected to the network 120 from which the computing system can receive the digitized documents 135a, b. In various embodiments, the devices 130a, b may be mobile devices, scanners, or any other suitable devices for digitizing documents (e.g., devices having integrated cameras for capturing digital images of documents).

The computing environment 100 includes a reference document server 140 communicatively connected to the network 120. The reference document server 140 includes a reference document repository 142 which includes the collection of digitized reference documents 145. The reference document server 140 is communicatively connected to a reference document processing system 146. The reference document processing system 146 is configured to process the reference documents 145 to generate (e.g., compute) reference document data 148 for storage in the reference document server 140. The reference document data 148 can include, for example, keypoints for each page of the reference documents 145 along with the respective descriptors of the keypoints, as described in more details below. In some embodiments, the reference document processing system 146 may be a part of the reference document server 140. Additionally or alternatively, the reference document processing system 146 may be combined with the computing system 110. That is, in some embodiments, the computing system 110 is configured to generate reference document data 148.

The computing environment 100 includes a data server 150 communicatively connected to the network 120 and configured to store data extracted from structured documents (e.g., documents 135a, b) by the computing system 110. The data server 150 may host one or more databases for the extracted data. As the computing system 110 may be configured to extract structured data from a variety of different kinds of structured documents or forms, the computing environment 100 may include a plurality of servers to host the extracted data. Furthermore, at least portions of the extracted data and/or databases holding the extracted data may be replicated across different servers. For example, at least a portion of the extracted data may be stored in the computing system 110.

The computing environment 100 includes a workstation 160 communicatively connected to the network 120. The workstation 160 includes a processing unit 162 which in turn may include one or more processors communicatively connected to memory and a network interface to connect to the network 120. The workstation 160 further includes a display 164 communicatively connected to the processing unit 162. The workstation 160 may be configured to generate on the display 164 a graphical user interface (GUI) displaying data obtained from the data server 150 via the network 120.

It should be noted that in different embodiments components of the computing environment 100 differ from what is depicted in FIG. 1, and/or may be combined in different ways. For example the computing system 110 may include the workstation 160, the data server 150, the reference document server 140, a variety of input devices (e.g., devices 130a, b), and/or the network 120.

In operation, the computing system 110 may receive (e.g., via the network 120) a structured document (e.g., document 135a or 135b) including data to be extracted. For example, the structured document may be a printed form that was filled out by hand. Extracting the data from the form may require that the computing system 110 identify the form and select an appropriate template (e.g., unfilled form) from among reference documents (e.g., reference document 145). The computing system 110 may be configured to process received documents one page at a time. Consequently, the computing system 110 may segregate the received document by page. The reference documents (e.g., reference documents 145) may similarly be segregated by page within the reference document repository 142 and/or by the computing system 110.

The computing system 110 may be configured to compute, e.g., by executing instructions of the algorithm 115, a set of keypoints within a document page of the received structured document. Along with computing the set of keypoints, the computing system 110 may compute respective keypoint descriptors. The descriptors may include vectors of quantities describing respective keypoints. It should be noted that the keypoints may represent collections of pixels within an image corresponding to the received structured document. Thus, keypoints are not points in the strict sense of the word, but instead collections of pixels, regions, shapes, or any other suitable image elements.

Generally, the computing system 110 may use the computed keypoints and the correspondent descriptors to select a reference document page that matches, as a template, the page of the received document. To that end, the computing system 110 may use the algorithm 115 to identify a filtered sets of matching keypoints for a suitable number of reference document pages (e.g., stored in the reference document repository 142). Identifying the filtered sets of matching keypoints may include, for each reference document page, identifying a filtered set of matching keypoints between the set of keypoints within the received document page and a set of keypoints within the reference document page. As discussed above, sets of keypoints and corresponding descriptors may be precomputed (e.g., by the reference document processing system 146) and stored as the reference document data 148 in the reference document server 140.

The computing system 110 may be configured to compute metrics for the reference document pages, and to select a matching (e.g., best or closest match) reference document page based on the computed metrics. The computing system 110 may use the algorithm 115 to compute the metrics for each of the candidate reference document pages. To that end, the algorithm 115 may include instructions for computing a homographic transformation between the received document page and the reference document page based on the filtered set of matching keypoints. The computing system 110 may then compute the respective metric for the reference document page based on the computed homographic transformation as described in more details below. The computed metrics for the candidate reference document pages may be indicative of respective probabilities of a match to the received document page. The computing system may then select/identify as the matching reference document page the reference document page associated with the metric indicating the highest probability of a match.

The computing system 110 may process the page of the received structured document using the selected matching reference document page as a template for extracting structured data, as described in more detail below. Generally, the computing system 110 may “subtract” the template from the received document page to isolate the data of interest (e.g., handwriting in a form). Portions of the data of interest may correspond to template regions indicative of fields in the form. The computing system 110 may extract image data in the regions indicative of fields as alphanumeric data using optical character recognition. The computing system 110 may then store the extracted data in the data server 150.

In one embodiment, the computing system 110 may retrieve (e.g., via the network 120) from the reference document server 140 each of the candidate reference document pages along with respective reference document data (e.g., keypoints and descriptors). In some embodiments, the candidate reference document pages may be pages from all the reference documents 145. In other embodiments the computing system 110 may select a portion of pages from the documents 145 based on preselection criteria, as described in more detail below. The computing system 110 may compare each of the pages retrieved from the reference document server 140 with a page (e.g., of a filled-out form) from a document (e.g., documents 135a, b) from which data is to be extracted to find a matching reference document page.

In other embodiments, the system 110 may be a distributed system, with at least one of the processors in a high-speed communicative connection with the reference document server 140. For example, the reference document server 140 may be a remote server (e.g., a cloud server) configured to run the algorithm 115 on a co-located remote processor. In this manner, the computing system may obviate the need to retrieve each of the candidate reference document pages from the reference document server via the network 120, potentially improving speed of finding the matching reference document page. To that end, a client portion of the system 110 may send the set of keypoints from the received document page from which data is to be extracted to the remote processor. The client portion of the system 110 may avoid sending the entirety of the received document page to the remote server to ensure data privacy. In some embodiments, however, the entirety of the received document page may be sent to the remote server. Generally, the distributed system 110 may receive a document for processing at a one processor, find a matching template using a second processor, and extract data from the received document using the first, the second, or a third processor. The different processors need not be co-located and may be communicatively connected by the network 120. The various configurations may optimize speed, data security, and case of maintenance of the system 110.

### Document Processing Sequences

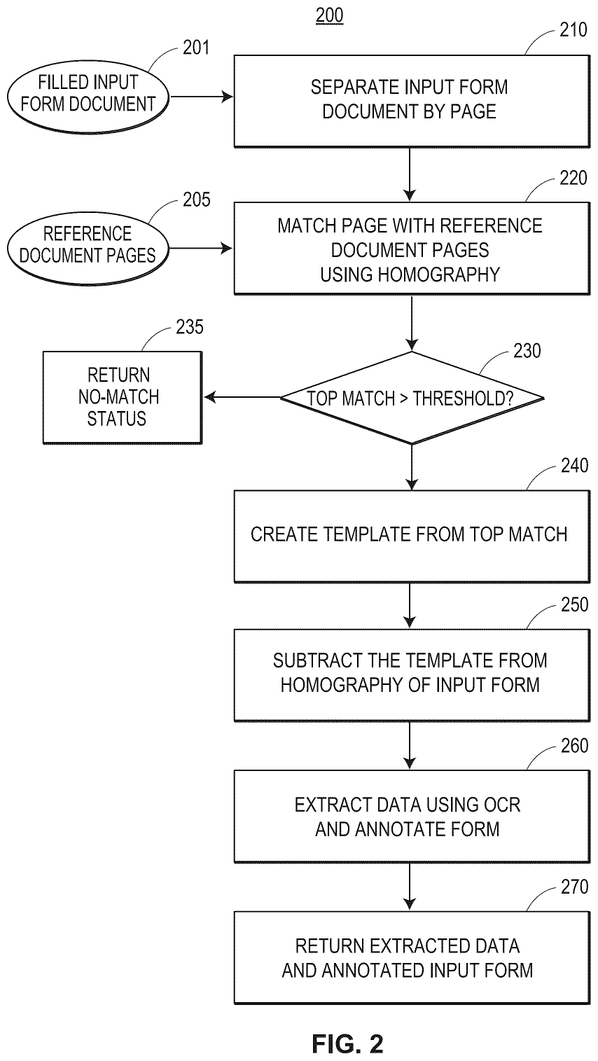

FIG. 2 depicts an example sequence 200 for extracting data from a structured input form document 201 (e.g., documents 135a, b) using reference document pages (e.g., pages of documents 145) using the techniques of this disclosure. The sequence 200 may be implemented by the computing system 110 of FIG. 1. The stages 210-270 of the sequence 200 may be implemented by the algorithms 115 and 116, for example.

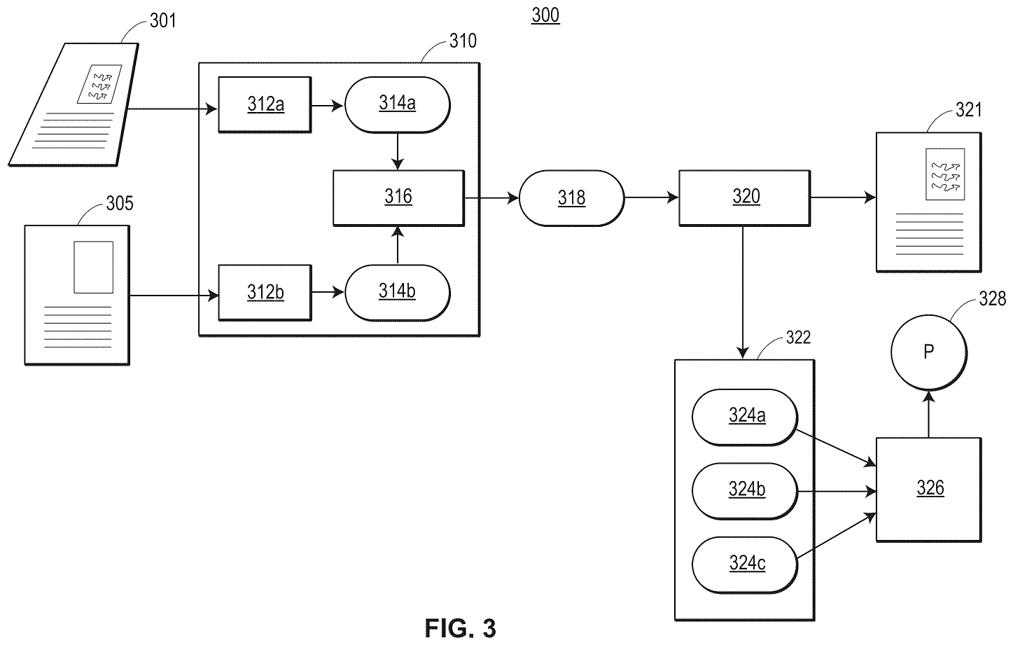

A page segregation stage 210 includes separating a document page from the filled input form document 201 and passing the separated document page to a matching stage 220. The separated document page may be referred to as the input document page or just the document page. The page segregation stage 210 may be performed, for example, by the matching algorithm 115. An example of the matching stage 220, which may be implemented by the matching algorithm 115, is described in detail with reference to sequence 300 of FIG. 3. In general, the matching stage 220 computes a plurality of metrics for the plurality of reference document pages 205. In the process of computing the metrics, the matching stage 220 computes homographic transformations of the document page of the input form document 201 onto the reference document pages 205 for which the metrics are computed.

In some embodiments, the plurality of reference document pages includes all pages of all reference documents stored at a reference document server (e.g., reference document server 140). In other embodiments, a system (e.g., computing system 110) may preselect reference document pages 205 based on the input form document 201. For example, the system may select a subset of reference documents based on identifying a form type (e.g., medical intake, financial, etc.) by reading a suitable identifier (e.g., a bar code) or, using OCR, a title on the input form 201. Additionally or alternatively, the system may use structural similarity measures or any other suitable statistical representations of an image to preselect the reference document pages 205 and/or respective reference documents. To that end, the sequence 200 may include a preselection stage.

The metrics computed at the matching stage indicate the quality of match between the respective reference document pages 205 and document page of the input form document 201 separated by the page segregation stage 210. A decision stage 230 may compare a reference document page with the metric indicating the highest probability of match to the document page separated by the page segregation stage 210. When the metric indicating the highest probability of match does not exceed a threshold metric, the decision stage 230 proceeds to a no-match notification stage 235. The no-match notification stage 235 returns a no-match status. In some embodiments, the no-match notification stage 235 sends a suitable number of reference document pages with top quality of match metrics for further processing (e.g., by a human) to identify whether one of the reference document pages is suitable as a template. The decision stage 230 and the no-match notification stage 235 may be implemented by the algorithm 115.

When the metric indicating the highest probability of match exceeds the threshold metric, the decision stage 230 proceeds to a template creation stage 240. The template creation stage 240 and subsequent stages 250-270 of the sequence 200 may be implemented by the data extraction algorithm 116. In some embodiments, the template creation stage 240 and the subsequent stages 250-270 of the sequence 200 are performed by a different portion of a distributed system than the previous stages 210-235.

The template creation stage 240 performs operations on the selected reference document page to generate a suitable template. For example, the template creation stage 240 may apply a blur filter to the selected reference document page to form a template and pass the template to a subtraction stage 250. Additionally or alternatively, the template creation stage 240 may identify regions within the template from which data is to be extracted from the input document page.

The subtraction stage 250 subtracts the template generated by the template creation stage 240 from the homographic transformation, generated by the matching stage 220, of the input document page onto the reference document page best matched to the input document page. As described in more detail with reference to FIG. 3, the homographic transformation effectively registers the input document page to the selected matching reference document page. The template creation stage 240 preserves the pixels of the selected matching reference document page and, consequently, a pixel-to-pixel correspondence between the input document page and the template. The subtraction process may include pixel-by-pixel subtraction of the template from the input document page and subsequent zeroing of all the negative values. In some embodiments, prior to the subtraction, the subtraction stage 250 converts both the input document page and the template to black and white images. In some embodiments, the conversion to black and white images is performed in one of the previous stages 210-240 of the sequence 200. A value of one may be assigned to all the black pixels, while a value of zero may be assigned to all the white pixels, for example. In such embodiments, subtracting the template from the input document page results in positive one values were the input document page pixel is black and the template pixel is white, a zero value when both corresponding pixels are black. When the template pixel is black and the input document page pixel is white, mathematical subtraction results, in such embodiments, in a value of negative one, which may be subsequently zeroed by the subtraction stage 250.

In other embodiments, at least the input document page retains grayscale levels, with higher values assigned to darker pixels. For example, the template creation stage 240 or the subtraction stage 250 may include assigning maximum grayscale levels to template pixels above a certain threshold, effectively creating a two-level template. In such embodiments, subtracting the template from the input document page would result in zeroing of pixels that correspond to the dark pixels of the template.

The subtraction stage 250 processes the input document page and passes the processed input document page (e.g., the input document page with the content corresponding to the template removed) to a data extraction stage 260. The data extraction stage 260 extracts data from the fields of the processed input form. In some embodiments, regions in the processed input form corresponding to the fields are available from metadata corresponding to the reference documents. Such metadata, for example, may be stored in the reference document repository 142 of FIG. 1. The metadata may associate pixel coordinates with different fields within the reference document. As described above, a homographic transformation registers pages of the input form document 201 onto the matched reference document pages. The registration process maps pixels of each page in the input form document 201 onto the respective pixels of the matched reference document page. In this manner, pixel coordinates in the processed input document page may be identified as fields based on the reference document metadata containing field coordinates. In other embodiments, field names may be identified during the data extraction stage 260.

In some embodiments, the data extraction stage 260 uses OCR to read alphanumeric data in the processed input document page. The data extraction stage 260 may create a dictionary or another suitable data structure with field identifiers and corresponding extracted field data. In some embodiments, the data extraction stage 260 annotates the input document page. Additionally or alternatively, the data extraction stage 260 may annotate the template generated by the template creation stage 240. In some embodiments, the annotations include highlighting field names and/or drawing boxes around fields based on identified field regions (e.g., rectangular bounds of pixels corresponding to fields). The field regions may be identified using intersection of union (IoU) or other suitable techniques. The data extraction stage 260 then passes the data structure, the extracted field data, annotations, and/or accompanying forms to a data return stage 270.

The data return stage 270 stores data extracted by the data extraction stage 260 in one or more suitable databases (e.g., the extracted data from data server 150 of FIG. 1). In some embodiments, the data return stage 270 stores data (e.g., templates and/or template annotations) on a reference document server (e.g., reference document server 140).

In some embodiments, the sequence 200 is based on homographic transformation of the reference document pages 205 to match the input form document 201, rather than transforming the input form document 201 to match the reference document pages 205. In some embodiments, the reference document pages 205 and the input document page are both transformed. In any case, transformations register the input form document 201 with respective reference document pages based on matching keypoints. The template creation stage 240 may create a template based on a transformed matching reference document page or may transform a pre-computed template using homography. Other stages may be adjusted accordingly.

FIG. 3 depicts an example sequence 300 for selecting a matching reference document page corresponding to an input document page 301 (e.g., page of the input form document 201). The sequence 300 may be an implementation of the matching stage 220 of the sequence 200 described with reference to FIG. 2, for example. The input document page 301 and a reference document page 305 are inputs into a keypoint matching stage 310. More specifically, in some embodiments, a keypoint detection sub-stage 312a of the keypoint matching stage 310 processes the input document page 301, while a keypoint detection sub-stage 312b processes the reference document page 305.

The keypoint detection sub-stage 312a produces a set of keypoint descriptors 314a, while the keypoint detection sub-stage 312b produces a set of keypoint descriptors 314b. A keypoint matching substage 316 generates or identifies a filtered set of pairs of matching keypoints 318, each pair including a keypoint from the input document page 301 and a keypoint from the reference document page 305. The filtered set of pairs of matching keypoints 318 may be referred to more simply as a filtered set of matching keypoints 318. The keypoint matching substage 316 identifies the filtered set of matching keypoints 318 by filtering potential matching keypoints based on suitable criteria, retaining only so-called “good matches.”

It should be noted, that the keypoint detection sub-stages 312a and b need not be executed contemporaneously. For example, a system (e.g., the computing system 110) may run a keypoint detection algorithm (e.g., algorithm 115) to preprocess the reference document page 305 and store keypoint data (e.g., in reference document data 148). In implementing the keypoint matching stage 310 after receiving the input document page 301 the system may use the keypoint detection sub-stage 312b to retrieve the previously computed keypoints and/or corresponding keypoint descriptors 314b from data stored at a remote server (e.g., reference document server 140). In some embodiments, the system is configured to compute keypoints and corresponding descriptors of the input document page 301, while another system (e.g., using a similar algorithm) is configured to compute keypoints and corresponding descriptors of the reference document page 305. The system may use the keypoint detection sub-stage 312b to retrieve the keypoints and the correspondence descriptors computed by a different computing system. One potential advantage of the configuration where the keypoints and the corresponding descriptors 314b of the reference document page 305 are computed by a separate computing system is the ability to independently process and store keypoint data for the reference document page 305. On the other hand, a potential advantage of using the same computing system to compute keypoints and descriptors for both the input document page 301 and the reference document page 305 is case of maintaining software to ensure consistent keypoint detection.

The keypoint detection sub-stages 312a and b may use a scale-invariant feature transform (SIFT) algorithm. SIFT algorithm is configured to identify consistent sets of features in an object under distortion. The corresponding feature descriptions, consequently, are also consistent under a variety of distortions. To apply SIFT algorithm, the keypoint matching stage 310 may perform a variety of preprocessing operations on the incoming document pages 301 and 302. The preprocessing operations may include converting images of documents to grayscale, interpolating images to similar resolution, removing shadows, removing gradients, and/or other suitable operations.

Additionally or alternatively, the keypoint matching stage 310 may use Harris corner detection, FAST (features from accelerated segment test), SURF (speed-up robust features), BRISK (binary robust invariant scalable keypoints), and/or any other suitable algorithm. As noted elsewhere in the disclosure, keypoints need not refer to points (e.g., specific pixels) but may include lines, curves, regions, and/or any other suitable features with identifiable location data.

The keypoint matching substage 316 may use a k-nearest neighbor (kNN) algorithm on pairs of suitably scaled descriptors to identify pairs of potential matching keypoints. In some embodiments, the keypoint matching substage 316 is configured to scale contributions of different descriptors to identifying pairs of potential matching keypoints and/or use any suitable distance measures to find neighbor distances. Additionally or alternatively, the matching substage 316 may be configured to use a combination of keypoint matching algorithms and may generate pairs of potential matching keypoints separately for each algorithm. The matching substage 316 may assign respective confidence measures to each pair of potential matching keypoints. The matching substage 316 identifies the filteres set of matching keypoints by applying any suitabla additional criteria to the pairs of potential matching keypoints. In some examples, the algorithms that identify the pairs of potential matching keypoints based on descriptor distances require no further filtering. In other examples, the matching substage 316 uses a ratio test, a spatial consistency check, or any other suitable criteria to a set of potential matching keypoints to identify the filtered set of matching keypoints. The ratio test includes computing a ration between the best and the second best match for a given keypoint and reject potential matches for which the ratio falls below a threshold. The spatial consistency check verifies that pairs of potential matching keypoints are spatially consistent. In any case, the matching pairs of points form a basis for registering the image of the input document page 301 and the reference document page 305.

A homography stage 320 takes the filtered set of matching keypoints 318 as an input and performs the homographic transformation of the input document page 301 to match the reference document page 305 to compute a transformed (or registered, corrected, etc.) input document page 321. In some embodiments, the homography stage 320 performs a homographic transformation to compute a transformed reference document page to match the input document page 301. In any case, the input document page 301 and the reference document page 305 are registered with each other. Homography is computed to align or register matching keypoint pairs from the filtered set of matching keypoints 318 and may be based on a random sample consensus (RANSAC) algorithm, for example. In some examples, the homography stage may be replaced by a stage performing rigid, affine, or any other suitable transformations.

Additionally, the homography stage 320 is configured to generate data for a feature vector generation stage 322. In turn, the feature vector generation stage 322 is configured to generate a feature vector for computing a probability of match between the input document page 301 and the reference document page 305.

The feature vector computed by the feature vector generation stage 322 includes features 324a-c. Generally, in some embodiments, computing the feature vector is based at least in part on the homographic transformation performed by the homography stage 320 and/or the filtered set of matching keypoints 318. The feature vector generation stage 322 computes one of the features 324a-c based on a proportion of keypoints from the set of keypoint descriptors 314a within the input document page that are within the filtered set of matching keypoints 318. The larger proportion indicates a higher likelihood that the input document page 301 matches the reference document page 305.

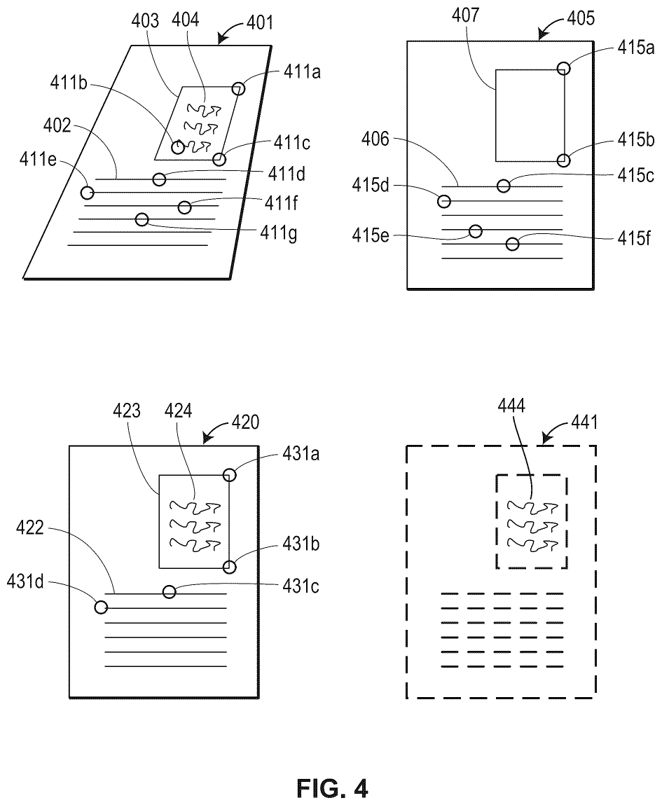

The feature vector generation stage 322 of the example sequence 300 generates features 324a-c based at least in part on determining which of the matching keypoints from the filtered set of matching keypoints 318 are consistent with the homographic transformation. As further discussed with reference to FIG. 4, the homographic transformation computed by the homography stage 320 may aim to minimize a cost function based on spatial distances between matching pairs of keypoints. The matching keypoints which are consistent with the resulting homographic transformation may be called “inliers.” Conversely, the matching keypoints which are not consistent with the resultant homographic transformation may be called “outliers.” It should be noted that the homography stage 320 may iteratively use and recompute the inliers to refine the homographic transformation in view of noise, occlusions, etc. The feature vector generation stage 322 may compute one of the features 324a-c based on a proportion of the inliers within the filtered set of matching keypoints. The larger proportion indicates a higher probability of match between the input document page 301 and the reference document page 305.

In some embodiments, either the homography stage 320 or the feature vector generation stage 322 may compute, based on the set of matched keypoints 318 and/or inliers, a matched area. The feature generation stage 322 may compute one of the features 324a-c based on a proportion of the matched area within the total area. In this case, areas may be represented by corresponding numbers of pixels.

The example sequence 300 includes a match probability estimation stage 326. The feature vector including features 324a-c serve as input into the match probability estimation stage 326. It should be noted that in some embodiments the match probability estimation stage 326 takes additional inputs. For example, some features or a match cost function may include statistical measures, such as histogram-based measures or structural similarity measures. The match probability estimation stage 326 computes a metric 328 that indicates a quality of match between the input document page 301 and the reference document page 305. The metric 328 may be referred to as the quality of match metric 328 and is indicative of a probability that the input document page 301 matches the reference document page 305. In summary, the example sequence 300 computes the transformed input document page 321 and the respective quality of match metric 328 for use, for example, the decision stage 230, the template creation stage 240, and the subtraction stage 250 of the example sequence 200.

The match probability estimation stage 326 may compute the quality of match metric 328 using a machine learning model. The machine learning model may include one or more decision trees, a support vector machine (SVM), an artificial neural network (ANN), and/or any other suitable model. In some embodiments, the match probability estimation stage 326 combines outputs of multiple models of different kind to compute the metric 328. For example, the match probability estimation stage 326 may use a random forest model to generate an output based on the features 324a-c. The match probability estimation stage 326 may compute the metric 328 based on the output of the random forest model by itself, or may combine the output of the random forest model with an output of another algorithm or machine learning model, for example.

FIG. 4 depicts example operations performed on a document page 401, which may be the input document page 301 and/or a page from the input form document 201, for example. The document page 401 may be a filled-out form (e.g., a health questionnaire, an application, etc.). The document page 401 includes form text 402, a form field 403, and a form field entry 404. Techniques of this disclosure may be used to extract and/or store data from the form field entry 404. The document page 401 may include any suitable number of fields, markings, section headings, etc. Furthermore, the document page 401 may include margin notes and/or other entries or additions to the form which are not associated with any fields. Techniques of this disclosure may also, or instead, be used to extract and/or store data from such notes, entries, and/or other type-set and/or handwritten additions.

As described above, extracting data from the document page 401 includes selecting a matching reference document page from a plurality of reference document pages. An example reference document page 405 includes form text 406 and a form field 407. The reference document page 405 need not be the matching reference document page, in this example. The similarities between the document page 401 and the reference document page 405 are for the purpose of illustration. While the reference document page 405 is illustrated with a substantially rectangular page, the document page 401 is illustrated with a perspective distortion. More generally, the document page 401 may include a variety of distortions, such as rotation, tears, overlapping text or other markings, uneven shading due to uneven illumination, blurring, staining, etc. In some embodiments, reference document pages may also include a variety of distortions, such as rotation, tears, overlapping text or other markings, uneven shading due to uneven illumination, blurring, staining, etc.

The techniques of this disclosure include computing, e.g., by the computing system 110, a set of keypoints 411a-g. The reference document page 405, similarly, includes a set of keypoints 415a-f. The keypoints of the reference document page 405 may be computed by the computing system 110, the reference document processing system 146, and/or one or more processors of another suitable system. The techniques of this disclosure further include identifying, for each of a number of reference document pages, a respective filtered set of matching keypoints.

A computing system may identify potential matching keypoints and a filtered set of matching keypoints based on keypoint descriptors. For each keypoint, the computing system may compute a descriptor vector of a suitable length (e.g., 4, 8, 16, 32, 64, 128, 256, 512, 1024, etc.). As in the case of a SIFT algorithm, for example, a descriptor may include statistics (e.g., a histogram) pertaining to gradient directions around keypoints which may be selected as local intensity maxima. In some embodiments, identifying matching keypoints between the document page 401 and the reference document page 405 includes comparing a descriptor vector for each of the keypoints 411a-g to each of the descriptor vectors of the keypoints 415a-f. Using, for example, a kNN or another suitable algorithm, the computing system selects for each of the keypoints 411a-g a matching keypoint from keypoints 415a-f by selecting a keypoint with a minimum Euclidean distance (or another suitable distance measure) between respective descriptor vectors. When more than one of the keypoints 411a-g match a single one of the keypoints 415a-f, the computing system selects a matching pair with the smaller distance. Furthermore, the computing system may discard matches with a distance above a suitable threshold distance from the filtered set of matching keypoints.

In the case of FIG. 4, the filtered set of matching keypoints includes pairs 411a and 415a, 411c and 415b, 411d and 415c, 411e and 415d, and 411g and 415f. Keypoints 411g and 415f do not have corresponding locations. In a sense, keypoints 411g and 415f are a false match. The assignment of the matching keypoint pair 411g and 415f is introduced herein to exemplify that certain keypoints may have “matching” descriptors without matching locations. For example, a keypoint associated with a capital “T” may match a capital “T” in another page. The example keypoints 411b, 411f, and 415f, on the other hand, remain unpaired because they do not have suitable matches (e.g., with a below-minimum descriptor distance).

The computing system uses the filtered set of matching keypoints to perform (e.g., at stage 220 of sequence 200 or stage 320 of sequence 300) a homographic transformation or mapping, registering the document page 401 to the reference document page 405. In some embodiments, the computer system performs the homographic transformation to minimize a suitable cost function. The cost function, for example, may be based at least in part on a root mean square (RMS) of distances (e.g., with respect to keypoint coordinates or pixel indices) between matching keypoints. The cost function may account for different qualities of match (e.g., based on descriptor distances) between keypoints by weighting distances in the RMS calculation. Additionally or alternatively, RMS weights may be based at least in part on keypoint indices. Applying the computed homographic transformation to the document page 401 generates a transformed document page 420 with transformed form text 422, transformed form field 423, and transformed form field entry 424.

The homographic transformation of the document page 401 generates transformed keypoints, such as inlier keypoints 431a-d. The inlier keypoints 431a-d are homographic transformations of the keypoints 411a, c-e, respectively. The inlier keypoints 431a-d spatially substantially coincide (e.g., are within a threshold spatial distance) with the matching keypoints of 415a-d, respectively. Thus, for the filtered set of matching keypoints including pairs 411a and 415a, 411c and 415b, 411d and 415c, 411e and 415d, and 411g and 415f, there are four inliers and one keypoint (keypoint 411g) that may be an outlier.

In the example of FIG. 4, the proportion of inliers 431a-d within the set of the document page portion of matching keypoints 411a, c-e, and g is ⅘ or 80%. On the other hand, the proportion of the matching keypoints 411a, c-e, and g within the total number of keypoints 411a-g in the document page 401 is 5/7 or about 71.4%. In some embodiments, the computing system computes (e.g., in the feature vector generation stage 322) the ratios of numbers of matching keypoints to total keypoints and inliers to matching keypoints and add the computed ratios to feature vectors. In some embodiments, the computing system computes features indicative of the proportions of inlier's to matching keypoints (from the filtered set) and matching keypoints (from the filtered set) to total keypoints (i.e., total number of keypoints) with any suitable mathematical expressions. The total number of keypoints may be computed by taking the smaller number between the number of keypoints in the document page 401 and the number of keypoints in the reference document page 405, the number of keypoints in the document page 401, or another suitable manner. As a feature indicative of the proportions of inliers to matching keypoints, the computing system may compute a ratio of inliers to the total number of pairs of matching keypoints (in the filtered set of matching keypoints). Additionally or alternatively, the computing system may identify matching areas. For example, a homographic algorithm may identify matching areas based on assemblies of matching keypoints (from the filtered set of matching keypoints). In some embodiments, the computing system computes (e.g., in the feature vector generation stage 322) a feature indicative of a ratio of the matching area to the total area of the document page 401 and add the computed feature to the feature vector.

It should be noted that the number of keypoints in the document page 401 in FIG. 4 is comparatively small (less than ten) for illustration purposes only. In other examples, a suitable number of keypoints may be 10, 30, 100, 300, 1000, 3000, 10000, 30000 or any other suitable number. In some embodiments, the computing system assembles a feature vector for each reference document page under consideration and evaluates a respective metric indicative of quality of match based on the feature vector for each reference document page. In other examples, the computing system assembles a feature vector for a group of reference document pages. That is, a feature vector may include ratios computed for different reference document pages. The group of reference document pages may be the total number of reference document pages or, for example, a set of reference document pages selected by an auxiliary method. The auxiliary method of selecting the group of reference document pages may include preprocessing the set of reference document pages based on one or more statistical measures. For example, the group may be narrowed to the reference document pages that have similar statistical measures to an input document page. Additionally or alternatively, the computing system may select a representative group of reference document pages that are weak matches with each other. For example, when there are many versions of each form, the computing system may select from among representatives of each group performs in one stage and narrow down the selection in another stage of the selection process.

Having identified a matching reference document page, the computing system proceeds to create a template (e.g., in the template creation stage of the sequence 200). Creating the template may include broadening form lines and text (e.g., by blurring). In some embodiments, a template for each reference document page may be stored in a reference document database (e.g., on the reference document server 140). In some embodiments, the computing system retrieve the template associated with the matching reference document page from a database.

The computing system may subtract the created or retrieved template associated with the matching reference document page from the transformed input page 420, as discussed with reference to FIG. 2, to generate a processed document page 441. The processed document page 441 in FIG. 4 is illustrated under the assumption that the reference document page 405 is a matching reference document page. The dashed lines in the processed document page 441 indicate elements of the transformed document page 420 removed by subtracting the template associated with the reference document page 405. The processing may leave only a processed form entry 444 which may be the transformed form entry 424, albeit with certain possible intensity scaling and corrections.

The computing system is configured to extract data from the processed form entry of the processed document page 441 using, for example, an OCR engine. The computing system may be configured to annotate form fields, as discussed above. Furthermore, the computing system may be configured to store extracted data from one or more fields in a suitable database (e.g., at the extracted data repository associated with data server 150).

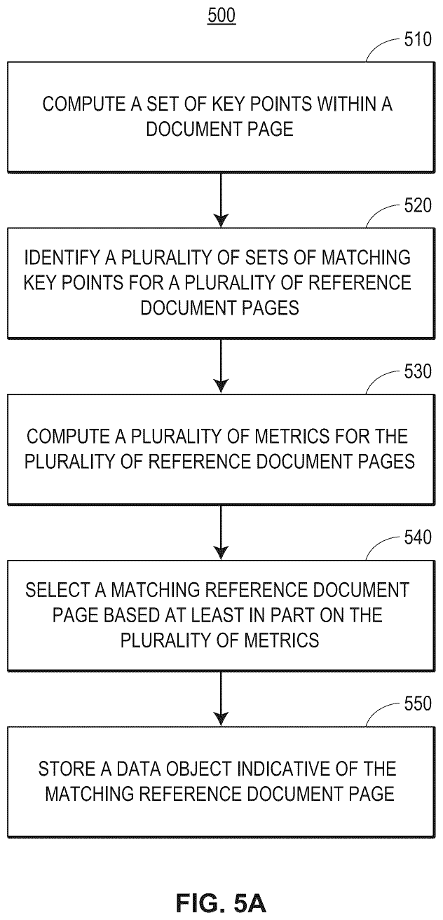

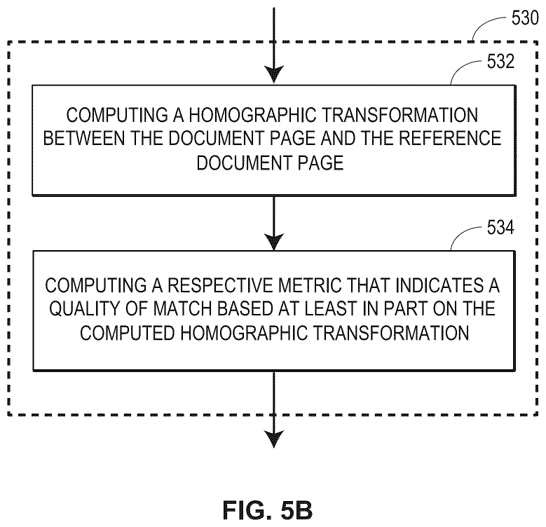

FIGS. 5A and 5B depict flow diagrams representing an example computer-implemented methods that implement techniques of this disclosure. FIG. 5A depicts a method 500 that includes blocks 510-530, 540 and 550. FIG. 5B depicts block 530 of the method 500 in more detail, according to one embodiment. The method 500 is implemented by one or more processors, e.g., by processor 112 of the computing system 110 and/or processor(s) of the reference document processing system 146.

At block 510, the method 500 includes computing a set of keypoints (e.g., keypoints 411a-g) within a document page (e.g., document pages 301, 401). In some embodiments, a computing system may compute keypoints using the SIFT algorithm. In other examples, the computing system may use Harris corner detection, FAST (features from accelerated segment test), SURF (speed-up robust features), BRISK or any other suitable algorithm. Still in other examples, the system may segment and classify specific marking (e.g., alignment marks), edges, or any other suitable features. Computing keypoints and/or other features may include computing respective descriptors. The descriptors may be vectors of suitable length. Distinct types of keypoints or other features may have respectively distinct types of descriptor vectors.

At block 520, the method 500 includes identifying a plurality of filtered sets of matching keypoints (e.g., matching keypoint pairs 411a and 415a, 411c and 415b, 411d and 415c, 411e and 415d, and 411g and 415f) for a plurality of reference document pages (e.g., reference document pages 305, 405). The method 500 includes identifying a filtered set of matching keypoints for each reference document page of the plurality of reference document pages. The plurality of reference document pages may be the entire collection of reference document pages or a pre-selected set. The filtered set of matching keypoints includes matching keypoints (e.g., pairs) between the set of keypoints within the document page computed at block 510 and a set of keypoints within the reference document page. The computing system may compute the set of keypoints in the reference document page in an ad hoc manner, for the purpose of matching to the input document. Additionally or alternatively, at least a portion of keypoints within an example reference document page may be pre-computed by any suitable computing system and stored for comparison to different input document pages. The matching of keypoints may be based on keypoint descriptors, as described above. The computing system identifies a filtered set of matching keypoints for each of the plurality of reference document pages.

At block 530, the method 500 includes computing a plurality of metrics for the plurality of reference document pages wherein computing the plurality of metrics includes, for each reference document page of the plurality of reference document pages. Computing the plurality of metrics may include computing one or more feature vectors as inputs into an ML model.

As depicted in FIG. 5B, the block 530 includes sub-blocks 532 and 532. At sub-block 532, the method 500 includes, to compute the plurality of metrics, computing a homographic transformation between the document page and the reference document page. Computing the homographic transformation is based at least in part on the filtered set of matching keypoints identified for the reference document page (i.e., matching between the reference document page and the document page).

At sub-block 534, the method includes computing a respective metric (i.e., for each of the plurality of reference document pages) that indicates a quality of match between the document page and the reference document page. Computing the respective metric is based at least in part on the computed (at sub-block 532) homographic transformation. Computing the respective metric may include computing a feature vector based at least in part on the homographic transformation and the filtered set of matching keypoints. Furthermore, computing the respective metric may further include using the computed feature vector as an input into an ML model. As discussed with reference to FIG. 4, computing the feature vector may include computing an element of the feature vector based on a proportion of the set of keypoints within the document page which are within the filtered set of matching keypoints. Additionally or alternatively, computing the feature vector may include identifying, within the filtered set of matching keypoints, a set of inliers, and computing an element of the feature vector based on a proportion of the inliers within the filtered set of matching keypoints.

Furthermore, computing the feature vector may include computing, based on the filtered set of matching keypoints, a matched area, and computing an element of the feature vector based on a proportion of the matched area within a total area. The area may be measured in pixels. To that end, the reference document page and the document page may be normalized and/or resampled to have a similar number of pixels.

An ML model for processing the feature vector may include one or more decision trees, a support vector machine, a neural network, and/or any other suitable model. For example, the ML model may be a random forest model. In some embodiments, the computing system uses multiple machine learning models to compute a metric indicative of quality of match. It should be noted that, in some embodiments, the techniques of this disclosure do not involve or require any use of an ML model to compute the plurality of metrics based on respective feature vectors. Any suitable algorithm (e.g., distance measures compared to thresholds, look-up tables, etc.) may compute at least a relative quality of match based on a respective computed feature vector.

Training an ML model used for processing the feature vector may include generating a training set of document pages based on the reference document pages. To that end, a training system may apply a variety of transformations to a reference document page to generate a document page for the training set. The transformations may include rotation, noise, cropping, overlaying text, nonuniform darkening, sharpening, saturation, blurring, and/or brightness changes.

It should be noted that training ML models for processing feature vectors need not be performed by the same one or more processors implementing the techniques of the disclosure for selecting a matching reference document page or extracting data from a form. In some embodiments, an ML model is trained by a processing system (e.g., reference document processing system 146) associated with a reference document server (e.g., reference document server 140). More generally, training an ML system may be performed using any suitable combination of processors, possibly including the computing system performing registration and matching of document pages associated with filled-out forms and reference document pages, computing system associated with the reference document server, and/or any other suitable computing systems.

Returning now to FIG. 5A, at block 540, the method 500 includes selecting a matching reference document page based at least in part on the plurality of metrics. In some embodiments, the computing system may select the reference document page with the highest metric as the matching reference document page. Additionally or alternatively, the system may select a set of reference document pages with above-threshold metrics and apply an additional algorithm to the selected set of reference document pages to make the final selection. That is, the method 500 may include identifying one or more candidate reference document pages based at least in part on the respective metrics. In some embodiments, the method 500 includes computing a respective structural similarity measure (e.g., MSSIM) for each of the one or more candidate reference document pages. The system may compute structural similarity measures vis-à-vis homographic transformations of the document page and/or the candidate reference document pages. Based at least in part on the respective structural similarity measures, the system may then select the matching reference document page from the one or more candidate reference document pages.

At block 550, the method 500 includes storing a data object indicative of the matching reference document page. The data object may be an indication of correspondence between the input document page and the matching reference document page. For example, the computing system may store a document page associated with a filled-out form or the homographic transformation of the document page along with a reference (e.g., in metadata) to the matching document page of a blank form. Additionally or alternatively, the computing system may extract data from the input document page and include the extracted data into the stored object or store the extracted data separately. In some embodiments, the computing system may identify (e.g., annotate) fields in the input document page and add the annotations to the stored object or store in a separate object.

In some embodiments, the method 500 further includes registering, by the one or more processors, the document page with the matching reference document page. The registration may include computing a homographic transformation of the document page and/or the matching reference document page to align respective matching keypoints (from the filtered set of matching keypoints).

Furthermore, in some embodiments, the method 500 includes generating a template based on the matching reference document page, as discussed, for example, with reference to FIGS. 2 and 4. The method 500 may include retrieving a previously computed template associated with the matching reference document page. In some embodiments, generating the template is based on a homographic transformation of the matching reference document page. Additionally or alternatively, the method 500 may include applying a homographic transformation to the template to align or register the template with the input document page.

In some embodiments, the method 500 includes computing a form input based on a difference between the registered document page and the template. The registered document page may be the input document page or a homographic transformation of the input document page. As discussed with reference to FIG. 2, subtracting the template from the transformed document page of a filled-out form removes the elements (e.g., text, lines, boxes, etc.) associated with the blank form, leaving only the form input (e.g., form entries).

In some embodiments, the method 500 includes identifying one or more form fields within the form input. Identifying the form fields may include identifying (e.g., using OCR) form field labels in the template or the document page. Additionally or alternatively, the computing system may obtain field regions from metadata associated with the matching reference document page. For example, such metadata may include regions and labels associated with form fields.

In some embodiments, the method 500 includes blurring (e.g., by applying a blur filter) the matching reference document page to generate the template. The computing system may use the blurred elements of the templates to null (or whitewash) the corresponding pixels in the transformed input document page. Additionally or alternatively, the method 500 may include inpainting the difference between the registered document page and the template to remove remnants of the difference that are not associated with form field.

In some embodiments, the method 500 includes computing a field value for each of the fields. Computing field values may include generating alphanumeric values using OCR for alphanumeric fields, creating a bitmap of regions associated with a field, reading bubbles or checkmarks (e.g., as binary values), etc. Extracted values may be stored in a dictionary with associated form fields and/or using any other suitable data structures in one or more suitable data repositories (e.g., databases). The computing system may suitably format stored data for presenting via a graphical user interface rendered on a display (e.g., display 164).

Of course, it is to be appreciated that the actions of the method 500 may be performed any suitable number of times, and that the actions described in reference to the method 500 may be performed in any suitable order.

### EXAMPLES

Example 1. A computer-implemented method comprising: computing, by one or more processors, a set of keypoints within a document page; identifying, by the one or more processors, a plurality of filtered sets of matching keypoints for a plurality of reference document pages, wherein identifying the plurality of filtered sets of matching keypoints includes, for each reference document page of the plurality of reference document pages, identifying a filtered set of matching keypoints between (i) the set of keypoints within the document page and (ii) a set of keypoints within the reference document page; computing, by the one or more processors, a plurality of metrics for the plurality of reference document pages, wherein computing the plurality of metrics includes, for each reference document page of the plurality of reference document pages: computing a homographic transformation between the document page and the reference document page based at least in part on the filtered set of matching keypoints identified for the reference document page; and computing a respective metric, of the plurality of metrics, that indicates a quality of match between the document page and the reference document page based at least in part on the computed homographic transformation; selecting, by the one or more processors, a matching reference document page based at least in part on the plurality of metrics; and storing, by the one or more processors, a data object indicative of the matching reference document page.

Example 2. The computer-implemented method of Example 1, wherein computing the respective metric indicating the quality of match includes: computing a feature vector based at least in part on the homographic transformation and the filtered set of matching keypoints; and applying a machine learning model to a feature vector, wherein the machine learning model is trained to compute the respective metric based on the feature vector and includes one or more decision trees, a support vector machine, and/or a neural network.

Example 3. The computer-implemented method of Example 2, wherein computing the feature vector includes computing an element of the feature vector based on a proportion of the set of keypoints within the document page which are within the filtered set of matching keypoints.

Example 4. The computer-implemented method of Examples 2 or 3, wherein computing the feature vector includes: identifying, within the filtered set of matching keypoints, a set of inliers; and computing an element of the feature vector based on a proportion of inliers, of the set of inliers, within the filtered set of matching keypoints.

Example 5. The computer-implemented method of any of Examples 2 through 4, wherein computing the feature vector includes: computing, based on the filtered set of matching keypoints, a matched area; and computing an element of the feature vector based on a proportion of the matched area within a total area.

Example 6. The computer-implemented method of any of Examples 2 through 5, wherein the machine learning model is a random forest model.

Example 7. The computer-implemented method of any of Examples 1 through 6, wherein selecting the matching reference document page includes: identifying one or more candidate reference document pages based at least in part on the respective metrics; computing a respective structural similarity measure for each of the one or more candidate reference document pages; and selecting the matching reference document page from the one or more candidate reference document pages based at least in part on the respective structural similarity measures.

Example 8. The computer-implemented method of any of Example 1, further comprising: registering, by the one or more processors, the document page with the matching reference document page; generating, by the one or more processors and based on the matching reference document page, a template; computing, by the one or more processors and based on a difference between the registered document page and the template, a form input; identifying, by the one or more processors, one or more form fields within the form input; and compute, by the one or more processors and for each of the one or more form fields, a field value.

Example 9. The computer-implemented method of Example 8, wherein generating the template includes applying a blur filter to the matching reference document page.

Example 10. The computer-implemented method of Examples 8 or 9, wherein computing the form input includes inpainting the difference between the registered document page and the template.

Example 11. A system comprising memory and one or more processors communicatively coupled to the memory, the one or more processors configured to: compute a set of keypoints within a document page; identify a plurality of filtered sets of matching keypoints for a plurality of reference document pages, wherein identifying the plurality of filtered sets of matching keypoints includes, for each reference document page of the plurality of reference document pages, identifying a filtered set of matching keypoints between (i) the set of keypoints within the document page and (ii) a set of keypoints within the reference document page; compute a plurality of metrics for the plurality of reference document pages, wherein computing the plurality of metrics includes, for each reference document page of the plurality of reference document pages: compute a homographic transformation between the document page and the reference document page based at least in part on the filtered set of matching keypoints identified for the reference document page; and compute a respective metric, of the plurality of metrics, that indicates a quality of match between the document page and the reference document page based at least in part on the computed homographic transformation; select a matching reference document page based at least in part on the plurality of metrics; and store a data object indicative of the matching reference document page.

Example 12. The system of Example 11, wherein computing the respective metric indicating the quality of match includes: computing a feature vector based at least in part on the homographic transformation and the filtered set of matching keypoints; and applying a machine learning model to a feature vector, wherein the machine learning model is trained to compute the respective metric based on the feature vector and includes one or more decision trees, a support vector machine, and/or a neural network.

Example 13. The system of Example 12, wherein computing the feature vector includes computing an element of the feature vector based on a proportion of the set of keypoints within the document page which are within the filtered set of matching keypoints.

Example 14. The system of Examples 12 or 13, wherein computing the feature vector includes: identifying, within the filtered set of matching keypoints, a set of inliers; and computing an element of the feature vector based on a proportion of inliers, of the set of inliers, within the filtered set of matching keypoints.

Example 15. The system of any of Example 12 through 14, wherein computing the feature vector includes: computing, based on the filtered set of matching keypoints, a matched area; and computing an element of the feature vector based on a proportion of the matched area within a total area.

Example 16. The system of any of Example 12 through 15, wherein the machine learning model is a random forest model.

Example 17. The system of any of Example 11 through 16, wherein selecting the matching reference document page includes: identifying one or more candidate reference document pages based at least in part on the respective metrics; computing a respective structural similarity measure for each of the one or more candidate reference document pages; and selecting the matching reference document page from the one or more candidate reference document pages based at least in part on the respective structural similarity measures.

Example 18. The system of any of Example 11 through 17, wherein the one or more processors are further configured to: register, by the one or more processors, the document page with the matching reference document page; generate, by the one or more processors and based on the matching reference document page, a template; compute, by the one or more processors and based on a difference between the registered document page and the template, a form input; identify, by the one or more processors, one or more form fields within the form input; and compute, by the one or more processors and for each of the one or more form fields, a field value.

Example 19. The system of Example 18, wherein generating the template includes applying a blur filter to the matching reference document page.

Example 20. The system of Examples 18 or 19, wherein computing the form input includes inpainting the difference between the registered document page and the template.

Example 21. One or more non-transitory computer-readable storage media including instructions that, when executed by one or more processors, cause the one or more processors to: compute a set of keypoints within a document page; identify a plurality of filtered sets of matching keypoints for a plurality of reference document pages, wherein identifying the plurality of filtered sets of matching keypoints includes, for each reference document page of the plurality of reference document pages, identifying a filtered set of matching keypoints between (i) the set of keypoints within the document page and (ii) a set of keypoints within the reference document page; compute a plurality of metrics for the plurality of reference document pages, wherein computing the plurality of metrics includes, for each reference document page of the plurality of reference document pages: compute a homographic transformation between the document page and the reference document page based at least in part on the filtered set of matching keypoints identified for the reference document page; and compute a respective metric, of the plurality of metrics, that indicates a quality of match between the document page and the reference document page based at least in part on the computed homographic transformation; select a matching reference document page based at least in part on the plurality of metrics; and store a data object indicative of the matching reference document page.

Example 22. The non-transitory computer-readable storage media of Example 21, wherein computing the respective metric indicating the quality of match includes: computing a feature vector based at least in part on the homographic transformation and the filtered set of matching keypoints; and applying a machine learning model to a feature vector, wherein the machine learning model is trained to compute the respective metric based on the feature vector and includes one or more decision trees, a support vector machine, and/or a neural network.

Example 23. The non-transitory computer-readable storage media of Example 22, wherein computing the feature vector includes computing an element of the feature vector based on a proportion of the set of keypoints within the document page which are within the filtered set of matching keypoints.

Example 24. The non-transitory computer-readable storage media of Examples 22 or 23, wherein computing the feature vector includes: identifying, within the filtered set of matching keypoints, a set of inliers; and computing an element of the feature vector based on a proportion of inliers, of the set of inliers, within the filtered set of matching keypoints.

Example 25. The non-transitory computer-readable storage media of any of Example 22 through 24, wherein computing the feature vector includes: computing, based on the filtered set of matching keypoints, a matched area; and computing an element of the feature vector based on a proportion of the matched area within a total area.

Example 26. The non-transitory computer-readable storage media of any of Example 22 through 25, wherein the machine learning model is a random forest model.

Example 27. The non-transitory computer-readable storage media of any of Example 21 through 26, wherein selecting the matching reference document page includes: identifying one or more candidate reference document pages based at least in part on the respective metrics; computing a respective structural similarity measure for each of the one or more candidate reference document pages; and selecting the matching reference document page from the one or more candidate reference document pages based at least in part on the respective structural similarity measures.

Example 28. The non-transitory computer-readable storage media of any of Example 21 through 27, wherein the one or more processors are further configured to: register, by the one or more processors, the document page with the matching reference document page; generate, by the one or more processors and based on the matching reference document page, a template; compute, by the one or more processors and based on a difference between the registered document page and the template, a form input; identify, by the one or more processors, one or more form fields within the form input; and compute, by the one or more processors and for each of the one or more form fields, a field value.

Example 29. The non-transitory computer-readable storage media of Example 28, wherein generating the template includes applying a blur filter to the matching reference document page.

Example 30. The non-transitory computer-readable storage media of Examples 28 or 29, wherein computing the form input includes inpainting the difference between the registered document page and the template.

Example 31. The computer-implemented method of Example 2, further comprising training the machine learning model.

Example 32. The computer-implemented method of Example 31, wherein the training is performed by the one or more processors.

Example 33. The computer-implemented method of Example 31, wherein: the one or more processors are included in a first computing entity; and the training is performed by one or more processors included in a second computing entity.

### Additional Considerations

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

The systems and methods described herein are directed to an improvement to computer functionality, and improve the functioning of conventional computers. Additionally, certain embodiments are described herein as including logic or a number of routines, subroutines, applications, or instructions. These may constitute either software (e.g., code embodied on a non-transitory, machine-readable medium) or hardware. In hardware, the routines, etc., are tangible units capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired), or temporarily configured (e.g., programmed) to operate in a certain manner or to perform certain operations described herein. Considering embodiments in which hardware modules are temporarily configured (e.g., programmed), each of the hardware modules need not be configured or instantiated at any one instance in time. For example, where the hardware modules include a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple of such hardware modules exist contemporaneously, communications may be achieved through signal transmission (e.g., over appropriate circuits and buses) that connect the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods or routines described herein may be at least partially processor-implemented. For example, at least some of the operations of a method may be performed by one or more processors or processor-implemented hardware modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The performance of certain of the operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

It should also be understood that, unless a term is expressly defined in this patent using the sentence “As used herein, the term ‘______’ is hereby defined to mean . . . ” or a similar sentence, there is no intent to limit the meaning of that term, either expressly or by implication, beyond its plain or ordinary meaning, and such term should not be interpreted to be limited in scope based upon any statement made in any section of this patent (other than the language of the claims). To the extent that any term recited in the claims at the end of this disclosure is referred to in this disclosure in a manner consistent with a single meaning, that is done for sake of clarity only so as to not confuse the reader, and it is not intended that such claim term be limited, by implication or otherwise, to that single meaning.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the description. This description, and the claims that follow, should be read to include one or at least one and the singular also may include the plural unless it is obvious that it is meant otherwise.

Upon reading this disclosure, those of skill in the art will appreciate still additional alternative structural and functional designs through the principles disclosed herein. Therefore, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

The patent claims at the end of this patent application are not intended to be construed under 35 U.S.C. § 112(f) unless traditional means-plus-function language is expressly recited, such as “means for” or “step for” language being explicitly recited in the claim(s).

What is claimed is:

1. A computer-implemented method comprising:
computing, by one or more processors, a set of keypoints within a document page;
identifying, by the one or more processors, a plurality of filtered sets of matching keypoints for a plurality of reference document pages, wherein identifying the plurality of filtered sets of matching keypoints includes, for each reference document page of the plurality of reference document pages, identifying a filtered set of matching keypoints between (i) the set of keypoints within the document page and (ii) a set of keypoints within the reference document page;
computing, by the one or more processors, a plurality of metrics for the plurality of reference document pages, wherein computing the plurality of metrics includes, for each reference document page of the plurality of reference document pages:
computing a homographic transformation between the document page and the reference document page based at least in part on the filtered set of matching keypoints identified for the reference document page; and
computing a respective metric, of the plurality of metrics, that indicates a quality of match between the document page and the reference document page based at least in part on the computed homographic transformation;
selecting, by the one or more processors, a matching reference document page based at least in part on the plurality of metrics; and
storing, by the one or more processors, a data object indicative of the matching reference document page.

2. The computer-implemented method of claim 1, wherein computing the respective metric indicating the quality of match includes:
computing a feature vector based at least in part on the homographic transformation and the filtered set of matching keypoints; and
applying a machine learning model to a feature vector, wherein the machine learning model is trained to compute the respective metric based on the feature vector and includes one or more decision trees, a support vector machine, and/or a neural network.

3. The computer-implemented method of claim 2, wherein computing the feature vector includes computing an element of the feature vector based on a proportion of the set of keypoints within the document page which are within the filtered set of matching keypoints.

4. The computer-implemented method of claim 2, wherein computing the feature vector includes:
identifying, within the filtered set of matching keypoints, a set of inliers; and
computing an element of the feature vector based on a proportion of inliers, of the set of inliers, within the filtered set of matching keypoints.

5. The computer-implemented method of claim 2, wherein computing the feature vector includes:
computing, based on the filtered set of matching keypoints, a matched area; and
computing an element of the feature vector based on a proportion of the matched area within a total area.

6. The computer-implemented method of claim 2, wherein the machine learning model is a random forest model.

7. The computer-implemented method of claim 1, wherein selecting the matching reference document page includes:
identifying one or more candidate reference document pages based at least in part on the respective metrics;
computing a respective structural similarity measure for each of the one or more candidate reference document pages; and
selecting the matching reference document page from the one or more candidate reference document pages based at least in part on the respective structural similarity measures.

8. The computer-implemented method of claim 1, further comprising:
registering, by the one or more processors, the document page with the matching reference document page;
generating, by the one or more processors and based on the matching reference document page, a template;
computing, by the one or more processors and based on a difference between the registered document page and the template, a form input;
identifying, by the one or more processors, one or more form fields within the form input; and
compute, by the one or more processors and for each of the one or more form fields, a field value.

9. The computer-implemented method of claim 8, wherein generating the template includes applying a blur filter to the matching reference document page.

10. The computer-implemented method of claim 8, wherein computing the form input includes inpainting the difference between the registered document page and the template.

11. A system comprising memory and one or more processors communicatively coupled to the memory, the one or more processors configured to:
compute a set of keypoints within a document page;
identify a plurality of filtered sets of matching keypoints for a plurality of reference document pages, wherein identifying the plurality of filtered sets of matching keypoints includes, for each reference document page of the plurality of reference document pages, identifying a filtered set of matching keypoints between (i) the set of keypoints within the document page and (ii) a set of keypoints within the reference document page;
compute a plurality of metrics for the plurality of reference document pages, wherein computing the plurality of metrics includes, for each reference document page of the plurality of reference document pages:
compute a homographic transformation between the document page and the reference document page based at least in part on the filtered set of matching keypoints identified for the reference document page; and
compute a respective metric, of the plurality of metrics, that indicates a quality of match between the document page and the reference document page based at least in part on the computed homographic transformation;
select a matching reference document page based at least in part on the plurality of metrics; and
store a data object indicative of the matching reference document page.

12. The system of claim 11, wherein computing the respective metric indicating the quality of match includes:
computing a feature vector based at least in part on the homographic transformation and the filtered set of matching keypoints; and
applying a machine learning model to a feature vector, wherein the machine learning model is trained to compute the respective metric based on the feature vector and includes one or more decision trees, a support vector machine, and/or a neural network.

13. The system of claim 12, wherein computing the feature vector includes computing an element of the feature vector based on a proportion of the set of keypoints within the document page which are within the filtered set of matching keypoints.

14. The system of claim 12, wherein computing the feature vector includes:
identifying, within the filtered set of matching keypoints, a set of inliers; and
computing an element of the feature vector based on a proportion of inliers, of the set of inliers, within the filtered set of matching keypoints.

15. The system of claim 12, wherein computing the feature vector includes:
computing, based on the filtered set of matching keypoints, a matched area; and
computing an element of the feature vector based on a proportion of the matched area within a total area.

16. The system of claim 12, wherein the machine learning model is a random forest model.

17. The system of claim 11, wherein selecting the matching reference document page includes:
identifying one or more candidate reference document pages based at least in part on the respective metrics;
computing a respective structural similarity measure for each of the one or more candidate reference document pages; and
selecting the matching reference document page from the one or more candidate reference document pages based at least in part on the respective structural similarity measures.

18. The system of claim 11, wherein the one or more processors are further configured to:
register, by the one or more processors, the document page with the matching reference document page;
generate, by the one or more processors and based on the matching reference document page, a template;
compute, by the one or more processors and based on a difference between the registered document page and the template, a form input;
identify, by the one or more processors, one or more form fields within the form input; and
compute, by the one or more processors and for each of the one or more form fields, a field value.

19. The system of claim 18, wherein generating the template includes applying a blur filter to the matching reference document page.

20. The system of claim 18, wherein computing the form input includes inpainting the difference between the registered document page and the template.

21. One or more non-transitory computer-readable storage media including instructions that, when executed by one or more processors, cause the one or more processors to:
compute a set of keypoints within a document page;
identify a plurality of filtered sets of matching keypoints for a plurality of reference document pages, wherein identifying the plurality of filtered sets of matching keypoints includes, for each reference document page of the plurality of reference document pages, identifying a filtered set of matching keypoints between (i) the set of keypoints within the document page and (ii) a set of keypoints within the reference document page;
compute a plurality of metrics for the plurality of reference document pages, wherein computing the plurality of metrics includes, for each reference document page of the plurality of reference document pages:
compute a homographic transformation between the document page and the reference document page based at least in part on the filtered set of matching keypoints identified for the reference document page; and
compute a respective metric, of the plurality of metrics, that indicates a quality of match between the document page and the reference document page based at least in part on the computed homographic transformation;
select a matching reference document page based at least in part on the plurality of metrics; and
store a data object indicative of the matching reference document page.

22. The non-transitory computer-readable storage media of claim 21, wherein computing the respective metric indicating the quality of match includes:
computing a feature vector based at least in part on the homographic transformation and the filtered set of matching keypoints; and
applying a machine learning model to a feature vector, wherein the machine learning model is trained to compute the respective metric based on the feature vector and includes one or more decision trees, a support vector machine, and/or a neural network.
